(19) United States
(12) Patent Application Publication
(10) Pub. No.: US 2020/0342059 A1
(43) Pub. Date: Oct. 29, 2020

(54) DOCUMENT CLASSIFICATION BY CONFIDENTIALITY LEVELS

(71) Applicant: ABBYY Production LLC, Moscow (RU)

(72) Inventors: Andrei Andreevich Ziuzin, Moscow (RU); Olesia Vladimirovna Uskova, Moscow (RU)

(21) Appl. No.: 16/400,229

(22) Filed: May 1, 2019

(30) Foreign Application Priority Data
Apr. 29, 2019 (RU) 2019113177

(51) Int. Cl. G06F 17/27

(52) U.S. Cl. CPC G06F 17/2785; G06F 17/2755; G06F 17/277; G06F 17/271

(57) ABSTRACT

Systems and methods for document classification by confidentiality levels. An example method comprises: receiving an electronic document comprising a natural language text; obtaining document metadata associated with the electronic document; extracting, from the natural language text, a plurality of information objects represented by the natural language text; computing a confidentiality level associated with the electronic document, by applying, to the extracted information objects and the document metadata, a set of classification rules; and associating the electronic document with a metadata item reflecting the computed confidentiality level.

### REFERENCE TO RELATED APPLICATIONS

The present application claims the benefit of priority under 35 U.S.C. § 119 to Russian Patent Application No. 2019113177 filed Apr. 29, 2019, the disclosure of which is incorporated by reference herein.

### TECHNICAL FIELD

The present disclosure is generally related to computing systems, and is more specifically related to systems and methods for document classification by confidentiality levels.

### BACKGROUND

Electronic or paper documents may include various sensitive information, such as private, privileged, confidential, or other information that is considered non-public. Such sensitive information may include, e.g., trade secrets, commercial secrets, personal data such as person identifying information (PII), etc.

### SUMMARY OF THE DISCLOSURE

In accordance with one or more aspects of the present disclosure, an example method of document classification by confidentiality levels may comprise: receiving an electronic document comprising a natural language text; obtain document metadata associated with the electronic document; extract, from the natural language text, a plurality of information objects represented by the natural language text; compute a confidentiality level associated with the electronic document, by applying, to the extracted information objects and the document metadata, a set of classification rules; and associate the electronic document with a metadata item reflecting the computed confidentiality level.

In accordance with one or more aspects of the present disclosure, an example computing system may comprise a memory and one or more processors, communicatively coupled to the memory. The processors may be configured to: receive an electronic document comprising a natural language text; obtain document metadata associated with the electronic document; extract, from the natural language text, a plurality of information objects represented by the natural language text; compute a confidentiality level associated with the electronic document, by applying, to the extracted information objects and the document metadata, a set of classification rules; and associate the electronic document with a metadata item reflecting the computed confidentiality level.

In accordance with one or more aspects of the present disclosure, an example computer-readable non-transitory storage medium may comprise executable instructions that, when executed by a computing system, cause the computing system to: receive an electronic document comprising a natural language text; obtain document metadata associated with the electronic document; extract, from the natural language text, a plurality of information objects represented by the natural language text; compute a confidentiality level associated with the electronic document, by applying, to the extracted information objects and the document metadata, a set of classification rules; and associate the electronic document with a metadata item reflecting the computed confidentiality level.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 schematically illustrates a flow diagram of an example method of document classification by confidentiality levels, in accordance with one or more aspects of the present disclosure;

FIG. 2 schematically illustrates an example graphical user interface (GUI) for specifying document confidentiality classification rules, in accordance with one or more aspects of the present disclosure;

FIG. 3 schematically illustrates a flow diagram of one illustrative example of a method of performing syntactico-semantic analysis of a natural language sentence, in accordance with one or more aspects of the present disclosure.

FIG. 4 schematically illustrates an example of a lexico-morphological structure of a sentence, in accordance with one or more aspects of the present disclosure;

FIG. 5 schematically illustrates language descriptions representing a model of a natural language, in accordance with one or more aspects of the present disclosure;

FIG. 6 schematically illustrates examples of morphological descriptions, in accordance with one or more aspects of the present disclosure;

FIG. 7 schematically illustrates examples of syntactic descriptions, in accordance with one or more aspects of the present disclosure;

FIG. 8 schematically illustrates examples of semantic descriptions, in accordance with one or more aspects of the present disclosure;

FIG. 9 schematically illustrates examples of lexical descriptions, in accordance with one or more aspects of the present disclosure;

FIG. 10 schematically illustrates example data structures that may be employed by one or more methods implemented in accordance with one or more aspects of the present disclosure;

FIG. 11 schematically illustrates an example graph of generalized constituents, in accordance with one or more aspects of the present disclosure;

FIG. 12 illustrates an example syntactic structure corresponding to the sentence illustrated by FIG. 11;

FIG. 13 illustrates a semantic structure corresponding to the syntactic structure of FIG. 12; and

FIG. 14 schematically illustrates a diagram of an example computing system implementing the methods described herein.

### DETAILED DESCRIPTION

Described herein are methods and systems for document classification by confidentiality levels.

Sensitive or otherwise non-public information may appear in different forms and may be stored by various media types, such as paper documents; electronic documents which may be stored in information systems, databases, file systems, etc., using various storage media (e.g., disks, memory cards, etc.); electronic mail messages; audio and video recordings, etc.

Document confidentiality classification may involve assigning to each document, based on the document content and/or metadata associated with the document, a particular confidentiality level of a predetermined set of categories. In an illustrative example, the set of categories may include the following confidentiality levels: confidential (the highest confidentiality level), restricted (medium confidentiality level), internal use only (low confidentiality level), and public (the lowest confidentiality level). In various other implementations, other sets of confidentiality levels may be used.

In certain implementations, document confidentiality classification may be performed based on a configurable set of rules. In an illustrative example, a user may specify one or more information object categories and corresponding confidentiality levels, such that if at least one information object of the specified information object category is found in a given document, the document confidentiality level is upgraded to the confidentiality level which is associated, by the relevant rule, with the information object category. In other words, the document receives the highest (i.e., the most restrictive) confidentiality level selected among the confidentiality levels associated with the information objects contained by the document.

In another illustrative example, the user may specify one or more document types (e.g., passport, driver's license, paystub, etc.) and corresponding confidentiality levels, such that if a given document is classified as belonging to the specified document type, the document confidentiality level is upgraded to the confidentiality level which is associated, by the relevant rule, with the document type. In other words, the document receives the highest confidentiality level selected among the confidentiality levels associated with the document type and the information objects contained by the document.

Accordingly, performing document confidentiality classification in accordance with one or more aspects of the present disclosure may involve identifying the document type and/or structure, recognizing the natural language text contained by at least some parts of the document (e.g., by performing optical character recognition (OCR)), analyzing the natural language text in order to recognize information objects (such as named entities), and applying the document confidentiality classification rules to the extracted information objects.

As explained in more detail herein below, an information object may be represented by a constituent of a syntactico-semantic structure and a subset of its immediate child constituents. Accordingly, information extraction may involve performing lexico-morphological analysis, syntactic analysis, and/or semantic analysis of the natural language text and analyzing the lexical, grammatical, syntactic and/or semantic features produced by such analysis in order to determine the degree of association of in information object with a certain information object category (e.g., represented by an ontology class). In certain implementations, the extracted information objects represent named entities, such as names of persons, organizations, locations, expressions of times, quantities, monetary values, percentages, etc. Such categories may be represented by concepts of a pre-defined or dynamically built ontology.

“Ontology” herein shall refer to a model representing information objects pertaining to a certain branch of knowledge (subject area) and relationships among such objects. An information object may represent a real life material object (such as a person or a thing) or a certain notion associated with one or more real life objects (such as a number or a word). An ontology may comprise definitions of a plurality of classes, such that each class corresponds to a certain notion pertaining to a specified knowledge area. Each class definition may comprise definitions of one or more objects associated with the class. Following the generally accepted terminology, an ontology class may also be referred to as concept, and an object belonging to a class may also be referred to as an instance of the concept. An information object may be characterized by one or more attributes. An attribute may specify a property of an information object or a relationship between a given information object and another information object. Thus, an ontology class definition may comprise one or more attribute definitions describing the types of attributes that may be associated with objects of the given class (e.g., type of relationships between objects of the given class and other information objects). In an illustrative example, a class “Person” may be associated with one or more information objects corresponding to certain persons. In another illustrative example, an information object “John Smith” may have an attribute “Smith” of the type “surname.”

Once the named entities have been recognized, the information extraction workflow may proceed to resolve co-references and anaphoric links between natural text tokens. “Co-reference” herein shall mean a natural language construct involving two or more natural language tokens that refer to the same entity (e.g., the same person, thing, place, or organization). For example, in the sentence “Upon his graduation from MIT, John was offered a position by Microsoft,” the proper noun “John” and the possessive pronoun “his” refer to the same person. Out of two co-referential tokens, the referenced token may be referred to as the antecedent, and the referring one as a proform or anaphora. Various methods of resolving co-references may involve performing syntactic and/or semantic analysis of at least a part of the natural language text.

Once the information objects have been extracted and co-references have been resolved, the information extraction workflow may proceed to identify relationships between the extracted information objects. One or more relationships between a given information object and other information objects may be specified by one or more properties of the information object that are reflected by one or more attributes. A relationship may be established between two information objects, between a given information object and a group of information objects, or between one group of information objects and another group of information objects. Such relationships and attributes may be expressed by natural language fragments (textual annotations) that may comprise a plurality of words of one or more sentences.

In an illustrative example, an information object of the class “Person” may have the following attributes: name, date of birth, residential address, and employment history. Each attribute may be represented by one or more textual strings, one or more numeric values, and/or one or more values of a specified data type (e.g., date). An attribute may be represented by a complex attribute referencing two or more information objects. In an illustrative example, the “address” attribute may reference information objects representing a numbered building, a street, a city, and a state. In an illustrative example, the “employment history” attribute may reference one or more information objects representing one or more employers and associated positions and employment dates.

Certain relationships among information objects may be also referred to as “facts.” Examples of such relationships include employment of person X by organization Y, location of a physical object X in geographical position Y, acquiring of organization X by organization Y, etc. a fact may be associated with one or more fact categories, such that a fact category indicates a type of relationship between information objects of specified classes. For example, a fact associated with a person may be related to the person's birth date and place, education, occupation, employment, etc. In another example, a fact associated with a business transaction may be related to the type of transaction and the parties to the transaction, the obligations of the parties, the date of signing the agreement, the date of the performance, the payments under the agreement, etc. Fact extraction involves identifying various relationships among the extracted information objects.

In an illustrative example, information extraction may involve applying one or more sets of production rules to interpret the semantic structures yielded by the syntactico-sematic analysis, thus producing the information objects representing the identified named entities. In another illustrative example, information extraction may involve applying one or more machine learning classifiers, such that each classifier would yield the degree of association of a given information object with a certain category of named entities.

Once the information extraction workflow for a given document is completed, the document confidentiality classification rules may be applied to the extracted information objects, their attributes, and their relationships, in order to identify a confidentiality level to be assigned to the document. In various illustrative examples, the document confidentiality level may be utilized for document labeling and handling. Document labeling may involve associating, with each electronic document, a metadata item indicative of the document confidentiality level. Document handling may include moving the document to a secure document storage corresponding to the document confidentiality level, establishing and enforcing access policies corresponding to the document confidentiality level, implementing access logging corresponding to the document confidentiality level, etc. In certain implementations, document handling may involve redacting the identified confidential information (e.g., by replacing each identified occurrence of a confidential information item with a predetermined or dynamically configurable substitute string, e.g., white spaces, black boxes, and/or other characters) or replacing the identified confidential information with fictitious data (e.g., for generating training data sets for machine learning classifier training), as described in more details herein below.

Thus, the present disclosure improves the efficiency and quality of document confidentiality classification by providing classification systems and methods that involves extracting information objects from the natural language text and applying document confidentiality classification rules to the extracted information objects. The methods described herein may be effectively used for processing large document corpora.

Systems and methods described herein may be implemented by hardware (e.g., general purpose and/or specialized processing devices, and/or other devices and associated circuitry), software (e.g., instructions executable by a processing device), or a combination thereof. Various aspects of the above referenced methods and systems are described in detail herein below by way of examples, rather than by way of limitation.

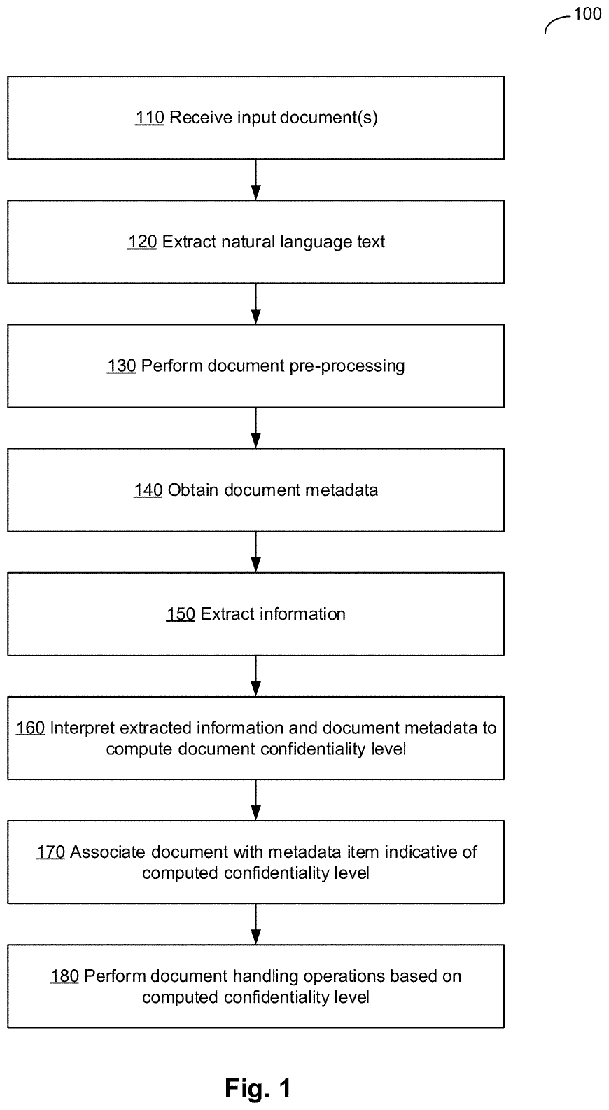

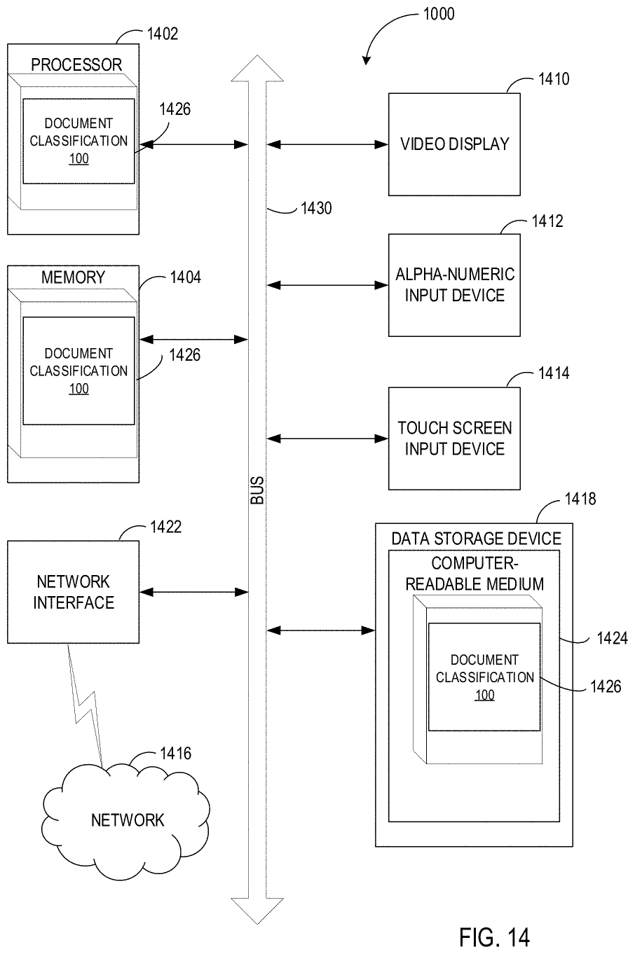

FIG. 1 schematically illustrates a flow diagram of an example method of document classification by confidentiality levels, in accordance with one or more aspects of the present disclosure. Method 100 and/or each of its individual functions, routines, subroutines, or operations may be performed by one or more processors of the computing system (e.g., computing system 1000 of FIG. 14) implementing the method.

“Computing system” herein shall refer to a data processing device having one or more general purpose processors, a memory, and at least one communication interface. Examples of computing systems that may employ the methods described herein include, without limitation, desktop computers, notebook computers, tablet computers, smart phones, and various other mobile and stationary computing systems.

In certain implementations, method 100 may be performed by a single processing thread. Alternatively, method 100 may be performed by two or more processing threads, each thread implementing one or more individual functions, routines, subroutines, or operations of the method. In an illustrative example, the processing threads implementing method 100 may be synchronized (e.g., using semaphores, critical sections, and/or other thread synchronization mechanisms). Alternatively, the processing threads implementing method 100 may be executed asynchronously with respect to each other. Therefore, while FIG. 1 and the associated description lists the operations of method 100 in certain order, various implementations of the method may perform at least some of the described operations in parallel and/or in arbitrary selected orders.

At block 110, the computing system implementing method 100 may receive one or more input documents. The input documents may appear in various formats and styles, such as images of paper documents, text files, audio- and/or video-files, electronic mail messages, etc.

At block 120, the computing system may extract the natural language text contained by the input document. In various illustrative examples, the natural language text may be produced by performing optical character recognition (OCR) of paper document images, performing speech recognition of audio recordings, extracting natural language text from web pages, electronic mail messages, etc.

At block 130, the computing system may optionally perform one or more document pre-processing operations. In certain implementations, the pre-processing operations may involve recognizing the document type. In an illustrative example, the document type may be determined based on the document metadata. In another illustrative example, the document type may be determined by comparing the document image and/or structure to one or more document templates, such that each of the templates is associated with a known document type. In another illustrative example, the document type may be determined by applying one or more machine learning classifiers to the document image, such that each classifier would yield the degree of association of the document image with a known document type.

In certain implementations, the pre-processing operations may involve recognizing the document structure. In an illustrative example, the document structure may include a multi-level hierarchical structure, in which the document sections are delimited by headings and sub-headings. In another illustrative example, the document structure may include one or more tables containing multiple rows and columns, at least some of which may be associated with headers, which in turn may be organized according to a multi-level hierarchy. In yet another illustrative example, the document structure may include a table structure containing a page header, a page body, and/or a page footer. In yet another illustrative example, the document structure may include certain text fields associated with pre-defined information types, such as a signature field, a date field, an address field, a name field, etc. The computing system may interpret the document structure to derive certain document structure information that may be utilized to enhance the textual information comprised by the document. In certain implementations, in analyzing structured documents, the computing system may employ various auxiliary ontologies comprising classes and concepts reflecting a specific document structure. Auxiliary ontology classes may be associated with certain production rules and/or classifier functions that may be applied to the plurality of semantic structures produced by the syntactico-semantic analysis of the corresponding document in order to impart, into the resulting set of semantic structures, certain information conveyed by the document structure.

At block 140, the computing system may obtain the document metadata associated with the input documents. In an illustrative example, the document metadata may include various file attributes (such as the file type, size, creation or modification date, author, owner, etc.). In another illustrative example, the document metadata may include various document attributes which may reflect the document type, structure, language, encoding, etc. In various illustrative examples, the document attributes may be represented by alphanumeric strings or <name=value> pairs. In certain implementations, the document metadata may be extracted from the file storing the document. Alternatively, the document metadata may be received from the file system, database, cloud-based storage system, or any other system storing the file.

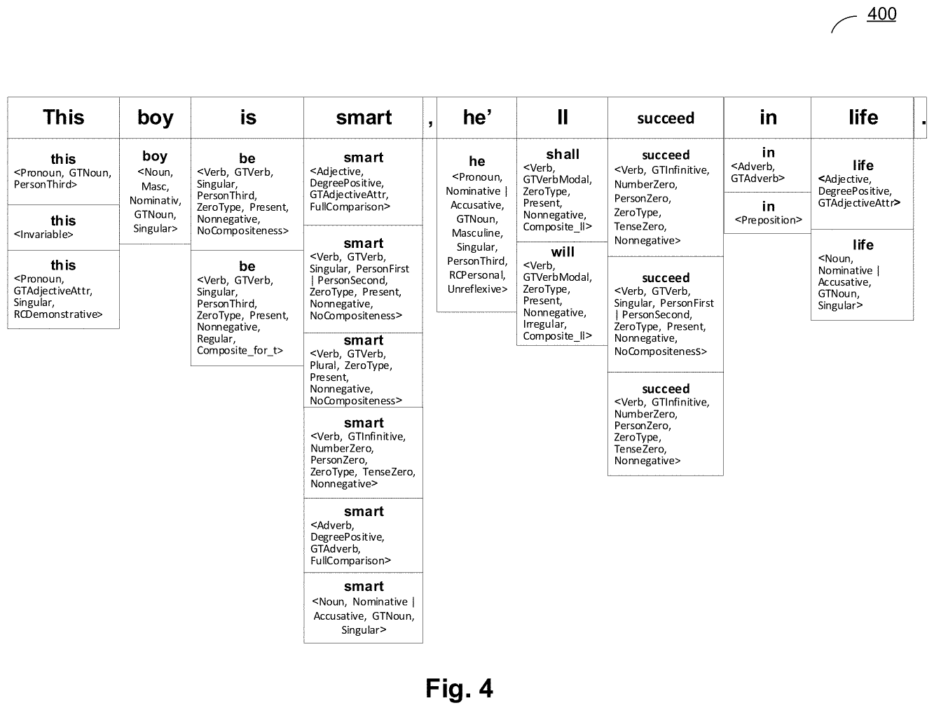

At block 150, the computing system may perform information extraction from the natural language text contained by the document. In an illustrative example, the computing system may perform lexico-morphological analysis of the natural language text. The lexico-morphological analysis may yield, for each sentence of the natural language text, a corresponding lexico-morphological structure. Such a lexico-morphological structure may comprise, for each word of the sentence, one or more lexical meanings and one or more grammatical meanings of the word, which may be represented by one or more <lexical meaning-grammatical meaning> pairs, which may be referred to as “morphological meanings.” An illustrative example of a method of performing lexico-morphological analysis of a sentence is described in more details herein below with references to FIG. 4.

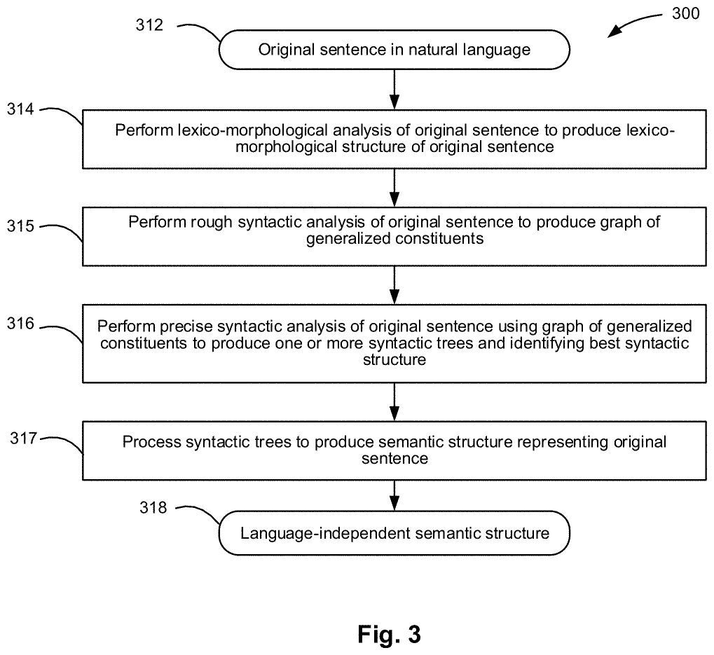

Additionally or alternatively to performing the lexico-morphological analysis, the computing system may perform syntactico-semantic analysis of the natural language text. The syntactico-sematic analysis may produce a plurality of language-independent semantic structures representing the sentences of the natural language text, as described in more details herein below with references to FIGS. 3-13. The language independence of the semantic structure allows performing language-independent text classification (e.g., classifying texts represented in multiple natural languages). The computing system may interpret the syntactico-semantic structures using a set of production rules to extract a plurality of information objects (such as named entities), as described in more detail herein below.

At block 160, the computing system may interpret the extracted information and the document metadata in order to determine the confidentiality level to be assigned to the input document. In certain implementations, interpreting the extracted information may involve applying a rule set which may include one or more user-configurable rules.

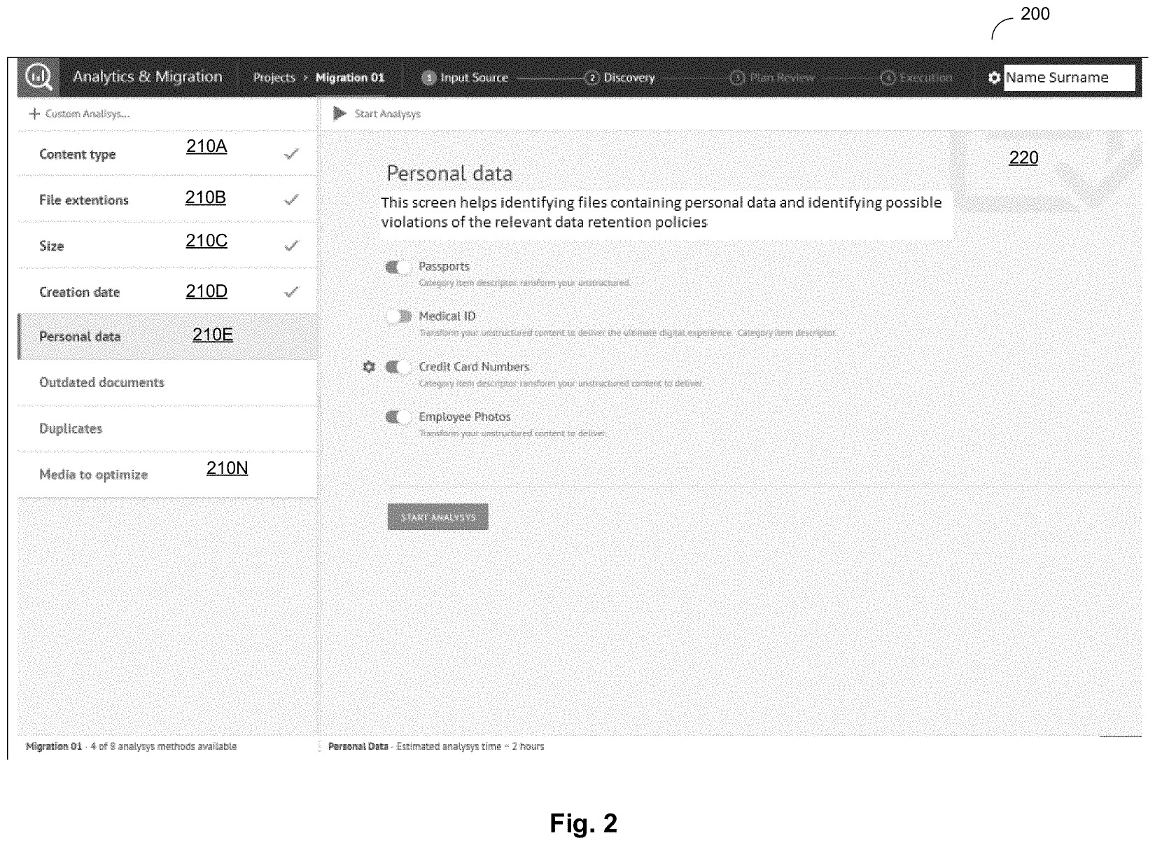

In an illustrative example, a user may specify (e.g., via a graphical user interface (GUI), as described in more detail herein below with reference to FIG. 2) one or more information object categories and their corresponding confidentiality levels, such that if at least one information object of the specified information object category is found in a given document, the document confidentiality level is upgraded to the confidentiality level which is associated, by the relevant rule, with the information object category. In other words, the document receives the highest confidentiality level selected among the confidentiality levels associated with the information objects contained by the document. In another illustrative example, a confidentiality rule may specify a combination of information object types, which, if found in the document, upgrades the confidentiality level of the document to a specified confidentiality level which is more restrictive than any of the confidentiality levels associated with individual information object categories comprised by the combination.

In various illustrative examples, the information object categories associated with heightened confidentiality levels may include personal names, addresses, phone numbers, credit card numbers, bank account numbers, identity document numbers, organization names, organization unit names, project names, product names, etc.

In certain implementations, the user may specify one or more document metadata item values (e.g., certain document authors, owners, organizations or organization units) and their corresponding confidentiality levels, such that if one of the specified metadata item values is found in the document metadata, the document confidentiality level is upgraded to the confidentiality level which is associated, by the relevant rule, with the metadata item value.

In certain implementations, the user may specify one or more document types (e.g., passport, driver's license, paystub, etc.) and corresponding confidentiality levels, such that if a given document is classified as belonging to the specified document type, the document confidentiality level is upgraded to the confidentiality level which is associated, by the relevant rule, with the document type. In other words, the document receives the highest confidentiality level selected among the confidentiality levels associated with the document type, individual information objects and/or combinations of the information objects contained by the document.

At block 170, the computing system may optionally associate, with the electronic document, a metadata item indicative of the computed document confidentiality level. The metadata item may be utilized by various systems and applications for handling the document in accordance with its assigned confidentiality level. In certain implementations, the metadata item may be stored within the file storing the document. Alternatively, the metadata item may be stored in the file system, database, cloud-based storage system, or any other system storing the file.

At block 180, the computing system may optionally perform one or more document handling tasks in accordance with the computed document confidentiality level. In various illustrative example, the computing system may move the document to a secure document storage corresponding to the document confidentiality level, establish and enforce access policies corresponding to the document confidentiality level, initiate access logging corresponding to the document confidentiality level, apply a document retention policy corresponding to the document confidentiality level, etc.

In certain implementations, the computing system may redact the identified confidential information. For each identified information object associated with a non-public confidentiality level, the computing system may identify a corresponding textual annotation in the natural language text contained by the document. “Textual annotation” herein shall refer to a contiguous text fragment (or a “span” including one or more words) corresponding to the main constituent of the syntactico-semantic structure (and, optionally, a subset of its child constituents) which represent the identified information object. A textual annotation may be characterized by its position in the text, including the starting position and the ending position. As noted herein above, in certain implementations, textual annotations corresponding to identified information objects that convey confidential information may be removed or replaced with a predetermined or dynamically configurable substitute string, e.g., white spaces, black boxes, and/or other characters or symbols. Alternatively, textual annotations corresponding to identified information objects that convey confidential information may be replaced with fictitious data (e.g., with randomly generated character strings or character strings extracted from a dictionary of fictitious data items). Documents in which the confidential information has been replaced with fictitious data may be utilized for forming training data sets for training machine learning classifiers which may then be employed for document confidentiality classification, such that each training data set is formed by a plurality of natural language texts with known confidentiality classification.

FIG. 2 schematically illustrates an example GUI for specifying document confidentiality classification rules, in accordance with one or more aspects of the present disclosure. In various implementations of the systems and methods described herein, other GUIs and/or other interfaces may be employed for specifying document confidentiality classification rules.

As schematically illustrated by FIG. 2, the GUI 200 may include multiple tabs 210A-210N. One or more tabs, such as tabs 210A-210D, may correspond to certain document metadata items, such as content type, file type, file size, file creation date, etc. Each of the tabs 210A-210D, when selected, may open a corresponding display panel (now shown in FIG. 2) on which the user may specify the values of the corresponding metadata items and the respective confidentiality levels which would be triggered if the document metadata matches the specified values. The personal data tab 210E, when selected, may open a corresponding display panel 220, which displays a list of document categories and/or information object categories, such that each list item is associated with a checkbox. Selecting the checkbox indicates that the corresponding document categories and/or information object categories should trigger a heightened (non-public) confidentiality level for the document associated with the selected document type and/or containing at least one information object of the selected category of information objects.

As noted herein above, the information extraction process may involve performing lexico-morphological analysis which would yield, for each sentence of the natural language text, a corresponding lexico-morphological structure. Additionally or alternatively, the information extraction process may involve a syntactico-semantic analysis, which would yield a plurality of language-independent semantic structures representing the sentences of the natural language text. The syntactico-semantic structures may be interpreted using a set of production rules, thus producing definitions of a plurality of information objects (such as named entities) represented by the natural language text.

The production rules employed for interpreting the semantic structures may comprise interpretation rules and identification rules. An interpretation rule may comprise a left-hand side represented by a set of logical expressions defined on one or more semantic structure templates and a right-hand side represented by one or more statements regarding the information objects representing the entities referenced by the natural language text.

A semantic structure template may comprise certain semantic structure elements (e.g., association with a certain lexical/semantic class, association with a certain surface or deep slot, the presence of a certain grammeme or semanteme etc.). The relationships between the semantic structure elements may be specified by one or more logical expressions (conjunction, disjunction, and negation) and/or by operations describing mutual positions of nodes within the syntactico-semantic tree. In an illustrative example, such an operation may verify whether one node belongs to a subtree of another node.

Matching the template defined by the left-hand side of a production rule to a semantic structure representing at least part of a sentence of the natural language text may trigger the right-hand side of the production rule. The right-hand side of the production rule may associate one or more attributes (reflecting lexical, syntactic, and/or semantic properties of the words of an original sentence) with the information objects represented by the nodes. In an illustrative example, the right-hand side of an interpretation rule may comprise a statement associating a token of the natural language text with a category of named entities.

An identification rule may be employed to associate a pair of information objects which represent the same real world entity. An identification rule is a production rule, the left-hand side of which comprises one or more logical expressions referencing the semantic tree nodes corresponding to the information objects. If the pair of information objects satisfies the conditions specified by the logical expressions, the information objects are merged into a single information object.

Various alternative implementations may employ classifier functions instead of the production rule. The classifier functions may, along with lexical and morphological features, utilize syntactic and/or semantic features produced by the syntactico-semantic analysis of the natural language text. In certain implementations, various lexical, grammatical, and or semantic attributes of a natural language token may be fed to one or more classifier functions. Each classifier function may yield a degree of association of the natural language token with a certain category of information objects. In various illustrative examples, each classifier may be implemented by a gradient boosting classifier, random forest classifier, support vector machine (SVM) classifier, neural network, and/or other suitable automatic classification methods. In certain implementations, the information object extraction method may employ a combination of production rules and classifier models.

In certain implementations, the computing system may, upon completing extraction of information objects, resolve co-references and anaphoric links between natural text tokens that have been associated with the extracted information objects. “Co-reference” herein shall mean a natural language construct involving two or more natural language tokens that refer to the same entity (e.g., the same person, thing, place, or organization).

Upon completing extraction of information objects, the computing system may apply one or more fact extraction methods to identify, within the natural language text, one or more facts associated with certain information objects. “Fact” herein shall refer to a relationship between information objects that are referenced by the natural language text. Examples of such relationships include employment of a person X by an organizational entity Y, location of an object X in a geo-location Y, acquiring an organizational entity X by an organizational entity Y, etc. Therefore, a fact may be associated with one or more fact categories. For example, a fact associated with a person may be related to the person's birth, education, occupation, employment, etc. In another example, a fact associated with a business transaction may be related to the type of transaction and the parties to the transaction, the obligations of the parties, the date of signing the agreement, the date of the performance, the payments under the agreement, etc. Fact extraction involves identifying various relationships among the extracted information objects.

In certain implementations, fact extraction may involve interpreting a plurality of semantic structures using a set of production rules, including interpretation rules and/or identification rules, as described in more detail herein above. Additionally or alternatively, fact extraction may involve using one or more classifier functions to process various lexical, grammatical, and or semantic attributes of a natural language sentence. Each classifier function may yield the degree of association of at least part of the natural language sentence with a certain category of facts.

In certain implementations, the computing system may represent the extracted information objects and their relationships by an RDF graph. The Resource Definition Framework assigns a unique identifier to each information object and stores the information regarding such an object in the form of SPO triplets, where S stands for “subject” and contains the identifier of the object, P stands for “predicate” and identifies some property of the object, and O stands for “object” and stores the value of that property of the object. This value can be either a primitive data type (string, number, Boolean value) or an identifier of another object. In an illustrative example, an SPO triplet may associate a token of the natural language text with a category of named entities.

FIG. 3 schematically illustrates a flow diagram of one illustrative example of a method 300 for performing syntactico-semantic analysis of a natural language sentence 312, in accordance with one or more aspects of the present disclosure. Method 300 may be applied to one or more syntactic units (e.g., sentences) comprised by a certain text corpus, in order to produce a plurality of syntactico-semantic trees corresponding to the syntactic units. In various illustrative examples, the natural language sentences to be processed by method 300 may be retrieved from one or more electronic documents which may be produced by scanning or otherwise acquiring images of paper documents and performing optical character recognition (OCR) to produce the texts associated with the documents. The natural language sentences may be also retrieved from various other sources including electronic mail messages, social networks, digital content files processed by speech recognition methods, etc.

At block 314, the computing system implementing the method may perform lexico-morphological analysis of sentence 312 to identify morphological meanings of the words comprised by the sentence. “Morphological meaning” of a word herein shall refer to one or more lemmas (i.e., canonical or dictionary forms) corresponding to the word and a corresponding set of values of grammatical features defining the grammatical value of the word. Such grammatical features may include the lexical category of the word and one or more morphological features (e.g., grammatical case, gender, number, conjugation type, etc.). Due to homonymy and/or coinciding grammatical forms corresponding to different lexico-morphological meanings of a certain word, two or more morphological meanings may be identified for a given word. An illustrative example of performing lexico-morphological analysis of a sentence is described in more detail herein below with references to FIG. 4.

At block 315, the computing system may perform rough syntactic analysis of sentence 312. The rough syntactic analysis may include identification of one or more syntactic models which may be associated with sentence 312 followed by identification of the surface (i.e., syntactic) associations within sentence 312, in order to produce a graph of generalized constituents. “Constituent” herein shall refer to a contiguous group of words of the original sentence, which behaves as a single grammatical entity. A constituent comprises a core represented by one or more words, and may further comprise one or more child constituents at lower levels. A child constituent is a dependent constituent and may be associated with one or more parent constituents.

At block 316, the computing system may perform precise syntactic analysis of sentence 312, to produce one or more syntactic trees of the sentence. The pluralism of possible syntactic trees corresponding to a given original sentence may stem from homonymy and/or coinciding grammatical forms corresponding to different lexico-morphological meanings of one or more words within the original sentence. Among the multiple syntactic trees, one or more best syntactic trees corresponding to sentence 312 may be selected, based on a certain quality metric function taking into account compatibility of lexical meanings of the original sentence words, surface relationships, deep relationships, etc.

At block 317, the computing system may process the syntactic trees to produce a semantic structure 318 corresponding to sentence 312. Semantic structure 318 may comprise a plurality of nodes corresponding to semantic classes, and may further comprise a plurality of edges corresponding to semantic relationships, as described in more detail herein below.

FIG. 4 schematically illustrates an example of a lexico-morphological structure of a sentence, in accordance with one or more aspects of the present disclosure. Example lexical-morphological structure 400 may comprise a plurality of “lexical meaning-grammatical value” pairs for example sentence. In an illustrative example, “11” may be associated with lexical meaning “shall” and “will”. The grammatical value associated with lexical meaning “shall” is <Verb, GTVerbModal, ZeroType, Present, Nonnegative, Composite II>. The grammatical value associated with lexical meaning “will” is <Verb, GTVerbModal, ZeroType, Present, Nonnegative, Irregular, Composite II>.

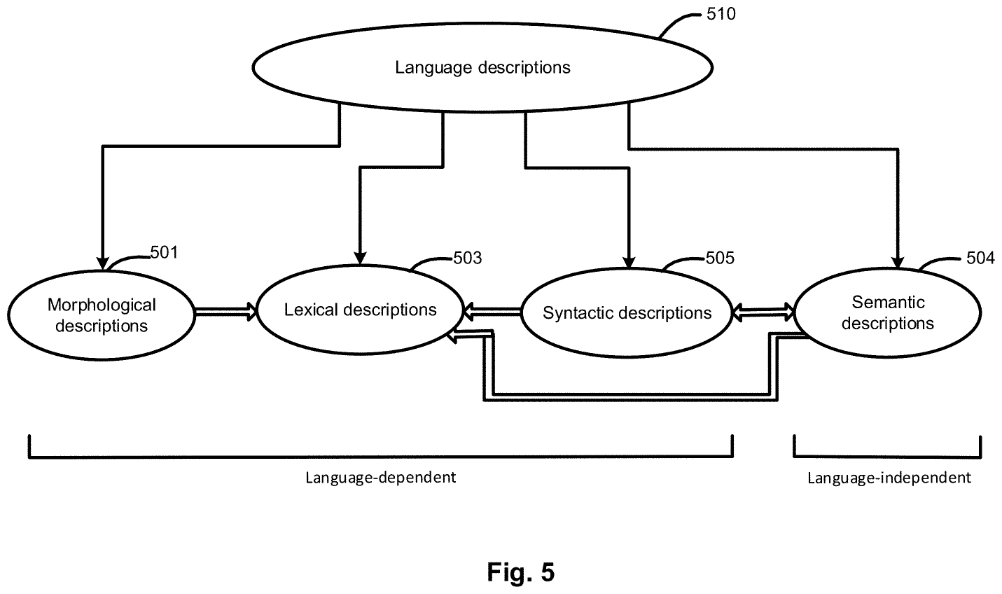

FIG. 5 schematically illustrates language descriptions 510 including morphological descriptions 501, lexical descriptions 503, syntactic descriptions 505, and semantic descriptions 504, and their relationship thereof. Among them, morphological descriptions 501, lexical descriptions 503, and syntactic descriptions 505 are language-specific. A set of language descriptions 510 represent a model of a certain natural language.

In an illustrative example, a certain lexical meaning of lexical descriptions 503 may be associated with one or more surface models of syntactic descriptions 505 corresponding to this lexical meaning. A certain surface model of syntactic descriptions 505 may be associated with a deep model of semantic descriptions 504.

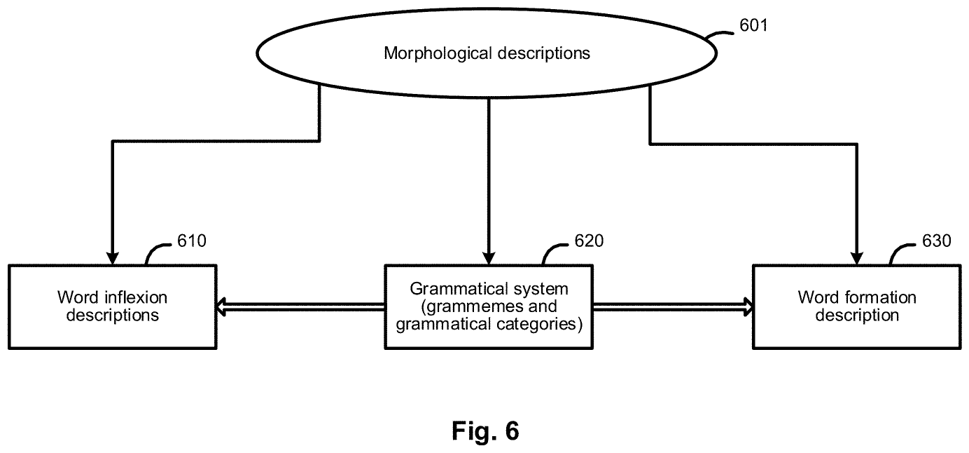

FIG. 6 schematically illustrates several examples of morphological descriptions. Components of the morphological descriptions 601 may include: word inflexion descriptions 610, grammatical system 620, and word formation description 630, among others. Grammatical system 620 comprises a set of grammatical categories, such as, part of speech, grammatical case, grammatical gender, grammatical number, grammatical person, grammatical reflexivity, grammatical tense, grammatical aspect, and their values (also referred to as “grammemes”), including, for example, adjective, noun, or verb; nominative, accusative, or genitive case; feminine, masculine, or neutral gender; etc. The respective grammemes may be utilized to produce word inflexion description 610 and the word formation description 630.

Word inflexion descriptions 610 describe the forms of a given word depending upon its grammatical categories (e.g., grammatical case, grammatical gender, grammatical number, grammatical tense, etc.), and broadly includes or describes various possible forms of the word. Word formation description 630 describes which new words may be constructed based on a given word (e.g., compound words).

According to one aspect of the present disclosure, syntactic relationships among the elements of the original sentence may be established using a constituent model. A constituent may comprise a group of neighboring words in a sentence that behaves as a single entity. A constituent has a word at its core and may comprise child constituents at lower levels. A child constituent is a dependent constituent and may be associated with other constituents (such as parent constituents) for building the syntactic descriptions 202 of the original sentence.

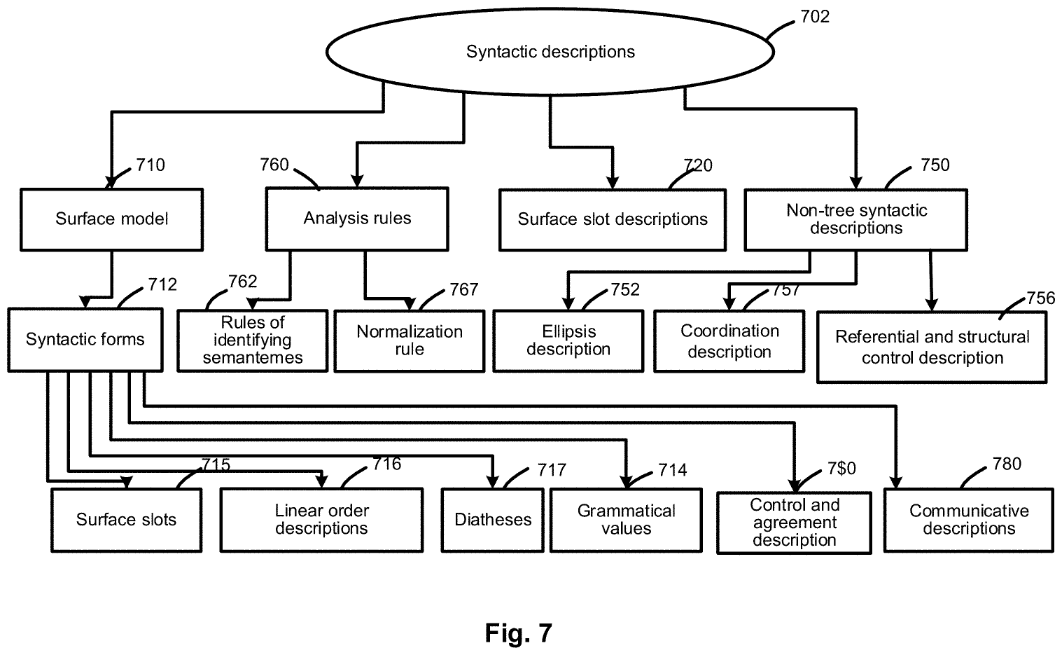

FIG. 7 illustrates exemplary syntactic descriptions. The components of the syntactic descriptions 702 may include, but are not limited to, surface models 710, surface slot descriptions 720, referential and structural control description 756, control and agreement description 740, non-tree syntactic description 750, and analysis rules 760. Syntactic descriptions 102 may be used to construct possible syntactic structures of the original sentence in a given natural language, taking into account free linear word order, non-tree syntactic phenomena (e.g., coordination, ellipsis, etc.), referential relationships, and other considerations.

Surface models 710 may be represented as aggregates of one or more syntactic forms (“syntforms” 712) employed to describe possible syntactic structures of the sentences that are comprised by syntactic description 102. In general, the lexical meaning of a natural language word may be linked to surface (syntactic) models 710. A surface model may represent constituents which are viable when the lexical meaning functions as the “core.” A surface model may include a set of surface slots of the child elements, a description of the linear order, and/or diatheses. “Diathesis” herein shall refer to a certain relationship between an actor (subject) and one or more objects, having their syntactic roles defined by morphological and/or syntactic means. In an illustrative example, a diathesis may be represented by a voice of a verb: when the subject is the agent of the action, the verb is in the active voice, and when the subject is the target of the action, the verb is in the passive voice.

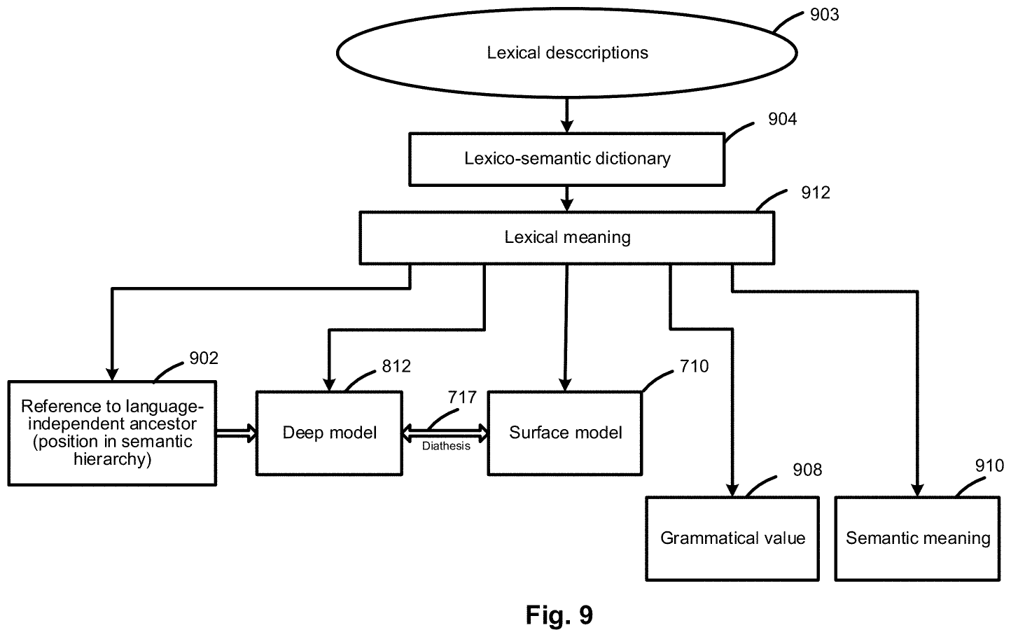

A constituent model may utilize a plurality of surface slots 715 of the child constituents and their linear order descriptions 716 to describe grammatical values 714 of possible fillers of these surface slots. Diatheses 717 may represent relationships between surface slots 715 and deep slots 517 (as shown in FIG. 9). Communicative descriptions 780 describe communicative order in a sentence.

Linear order description 716 may be represented by linear order expressions reflecting the sequence in which various surface slots 715 may appear in the sentence. The linear order expressions may include names of variables, names of surface slots, parenthesis, grammemes, ratings, the “or” operator, etc. In an illustrative example, a linear order description of a simple sentence of “Boys play football” may be represented as “Subject Core Object_Direct,” where Subject, Core, and Object_Direct are the names of surface slots 715 corresponding to the word order.

Communicative descriptions 780 may describe a word order in a syntform 712 from the point of view of communicative acts that are represented as communicative order expressions, which are similar to linear order expressions. The control and concord description 740 may comprise rules and restrictions which are associated with grammatical values of the related constituents and may be used in performing syntactic analysis.

Non-tree syntax descriptions 750 may be created to reflect various linguistic phenomena, such as ellipsis and coordination, and may be used in syntactic structures transformations which are generated at various stages of the analysis according to one or more aspects of the present disclosure. Non-tree syntax descriptions 750 may include ellipsis description 752, coordination description 757, as well as referential and structural control description 730, among others.

Analysis rules 760 may generally describe properties of a specific language and may be used in performing the semantic analysis. Analysis rules 760 may comprise rules of identifying semantemes 762 and normalization rules 767. Normalization rules 767 may be used for describing language-dependent transformations of semantic structures.

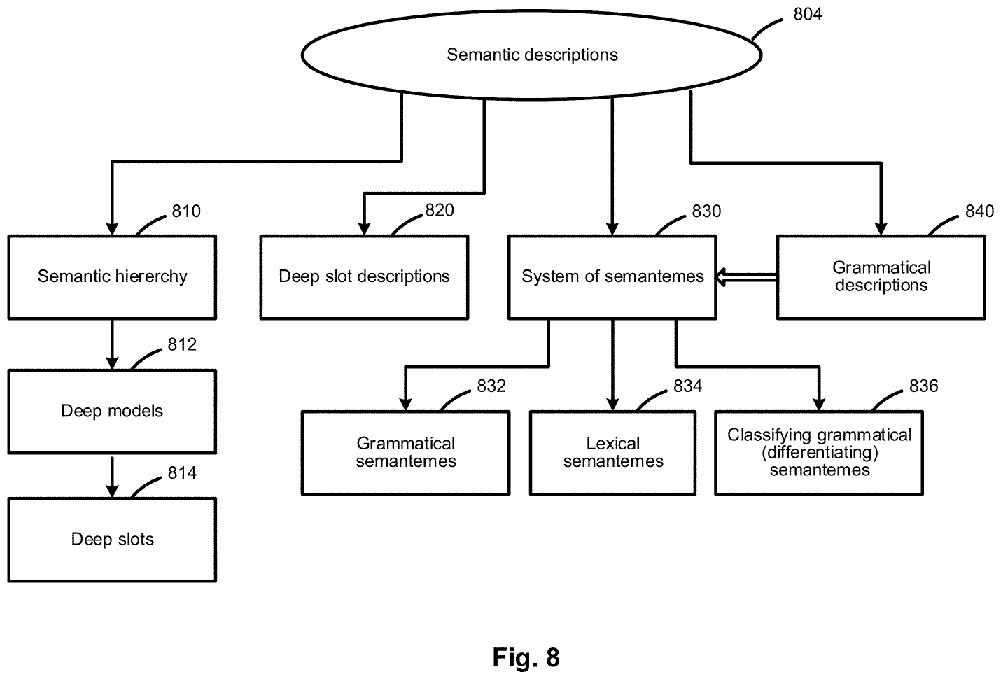

FIG. 8 illustrates exemplary semantic descriptions. Components of semantic descriptions 804 are language-independent and may include, but are not limited to, a semantic hierarchy 810, deep slots descriptions 820, a set of semantemes 830, and pragmatic descriptions 840.

The core of the semantic descriptions may be represented by semantic hierarchy 810 which may comprise semantic notions (semantic entities) which are also referred to as semantic classes. The latter may be arranged into hierarchical structure reflecting parent-child relationships. In general, a child semantic class may inherit one or more properties of its direct parent and other ancestor semantic classes. In an illustrative example, semantic class SUBSTANCE is a child of semantic class ENTITY and the parent of semantic classes GAS, LIQUID, METAL, WOOD_MATERIAL, etc.

Each semantic class in semantic hierarchy 810 may be associated with a corresponding deep model 812. Deep model 812 of a semantic class may comprise a plurality of deep slots 814 which may reflect semantic roles of child constituents in various sentences that include objects of the semantic class as the core of the parent constituent. Deep model 812 may further comprise possible semantic classes acting as fillers of the deep slots. Deep slots 814 may express semantic relationships, including, for example, “agent,” “addressee,” “instrument,” “quantity,” etc. A child semantic class may inherit and further expand the deep model of its direct parent semantic class.

Deep slots descriptions 820 reflect semantic roles of child constituents in deep models 812 and may be used to describe general properties of deep slots 814. Deep slots descriptions 820 may also comprise grammatical and semantic restrictions associated with the fillers of deep slots 814. Properties and restrictions associated with deep slots 814 and their possible fillers in various languages may be substantially similar and often identical. Thus, deep slots 814 are language-independent.

System of semantemes 830 may represents a plurality of semantic categories and semantemes which represent meanings of the semantic categories. In an illustrative example, a semantic category “DegreeOfComparison” may be used to describe the degree of comparison and may comprise the following semantemes: “Positive,” “ComparativeHigherDegree,” and “SuperlativeHighestDegree,” among others. In another illustrative example, a semantic category “RelationToReferencePoint” may be used to describe an order (spatial or temporal in a broad sense of the words being analyzed), such as before or after a reference point, and may comprise the semantemes “Previous” and “Subsequent.”. In yet another illustrative example, a semantic category “EvaluationObjective” can be used to describe an objective assessment, such as “Bad,” “Good,” etc.

System of semantemes 830 may include language-independent semantic features which may express not only semantic properties but also stylistic, pragmatic and communicative properties. Certain semantemes may be used to express an atomic meaning which corresponds to a regular grammatical and/or lexical expression in a natural language. By their intended purpose and usage, sets of semantemes may be categorized, e.g., as grammatical semantemes 832, lexical semantemes 834, and classifying grammatical (differentiating) semantemes 836.

Grammatical semantemes 832 may be used to describe grammatical properties of the constituents when transforming a syntactic tree into a semantic structure. Lexical semantemes 834 may describe specific properties of objects (e.g., “being flat” or “being liquid”) and may be used in deep slot descriptions 820 as restriction associated with the deep slot fillers (e.g., for the verbs “face (with)” and “flood,” respectively). Classifying grammatical (differentiating) semantemes 836 may express the differentiating properties of objects within a single semantic class. In an illustrative example, in the semantic class of HAIRDRESSER, the semanteme of <<RelatedToMen>> is associated with the lexical meaning of “barber,” to differentiate from other lexical meanings which also belong to this class, such as “hairdresser,” “hairstylist,” etc. Using these language-independent semantic properties that may be expressed by elements of semantic description, including semantic classes, deep slots, and semantemes, may be employed for extracting the semantic information, in accordance with one or more aspects of the present invention.

Pragmatic descriptions 840 allow associating a certain theme, style or genre to texts and objects of semantic hierarchy 810 (e.g., “Economic Policy,” “Foreign Policy,” “Justice,” “Legislation,” “Trade,” “Finance,” etc.). Pragmatic properties may also be expressed by semantemes. In an illustrative example, the pragmatic context may be taken into consideration during the semantic analysis phase.

FIG. 9 illustrates exemplary lexical descriptions. Lexical descriptions 203 represent a plurality of lexical meanings 912, in a certain natural language, for each component of a sentence. For a lexical meaning 912, a relationship 902 to its language-independent semantic parent may be established to indicate the location of a given lexical meaning in semantic hierarchy 510.

A lexical meaning 912 of lexical-semantic hierarchy 510 may be associated with a surface model 710 which, in turn, may be associated, by one or more diatheses 717, with a corresponding deep model 812. A lexical meaning 912 may inherit the semantic class of its parent, and may further specify its deep model 812.

A surface model 710 of a lexical meaning may comprise includes one or more syntforms 412. A syntform, 412 of a surface model 710 may comprise one or more surface slots 415, including their respective linear order descriptions 419, one or more grammatical values 414 expressed as a set of grammatical categories (grammemes), one or more semantic restrictions associated with surface slot fillers, and one or more of the diatheses 717. Semantic restrictions associated with a certain surface slot filler may be represented by one or more semantic classes, whose objects can fill the surface slot.

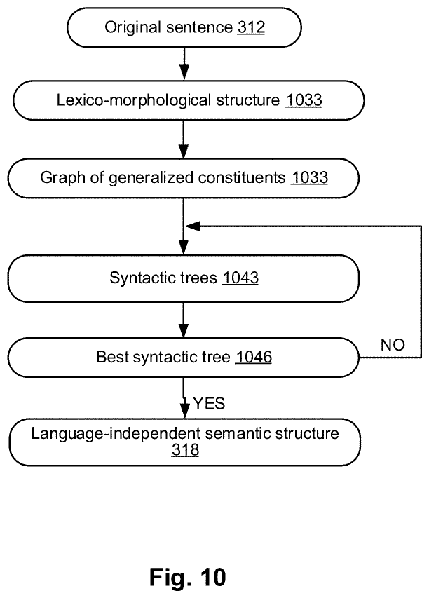

FIG. 10 schematically illustrates example data structures that may be employed by one or more methods described herein. Referring again to FIG. 3, at block 314, the computing system implementing the method may perform lexico-morphological analysis of sentence 312 to produce a lexico-morphological structure 1033 of FIG. 10. Lexico-morphological structure 1033 may comprise a plurality of mapping of a lexical meaning to a grammatical value for each lexical unit (e.g., word) of the original sentence. FIG. 4 schematically illustrates an example of a lexico-morphological structure.

Referring again to FIG. 3, at block 315, the computing system may perform rough syntactic analysis of original sentence 312 in order to produce a graph of generalized constituents 1033 of FIG. 10. Rough syntactic analysis involves applying one or more possible syntactic models of possible lexical meanings to each element of a plurality of elements of the lexico-morphological structure 1033, in order to identify a plurality of potential syntactic relationships within original sentence 312, which are represented by graph of generalized constituents 1033.

Graph of generalized constituents 1033 may be represented by an acyclic graph comprising a plurality of nodes corresponding to the generalized constituents of original sentence 312, and further comprising a plurality of edges corresponding to the surface (syntactic) slots, which may express various types of relationship among the generalized lexical meanings. The method may apply a plurality of potentially viable syntactic models for each element of a plurality of elements of the lexico-morphological structure of original sentence 312 in order to produce a set of core constituents of original sentence 312. Then, the method may consider a plurality of viable syntactic models and syntactic structures of original sentence 312 in order to produce graph of generalized constituents 1033 based on a set of constituents. Graph of generalized constituents 1033 at the level of the surface model may reflect a plurality of viable relationships among the words of original sentence 312. As the number of viable syntactic structures may be relatively large, graph of generalized constituents 1033 may generally comprise redundant information, including relatively large numbers of lexical meaning for certain nodes and/or surface slots for certain edges of the graph.

Graph of generalized constituents 1033 may be initially built as a tree, starting with the terminal nodes (leaves) and moving towards the root, by adding child components to fill surface slots 415 of a plurality of parent constituents in order to reflect all lexical units of original sentence 312.

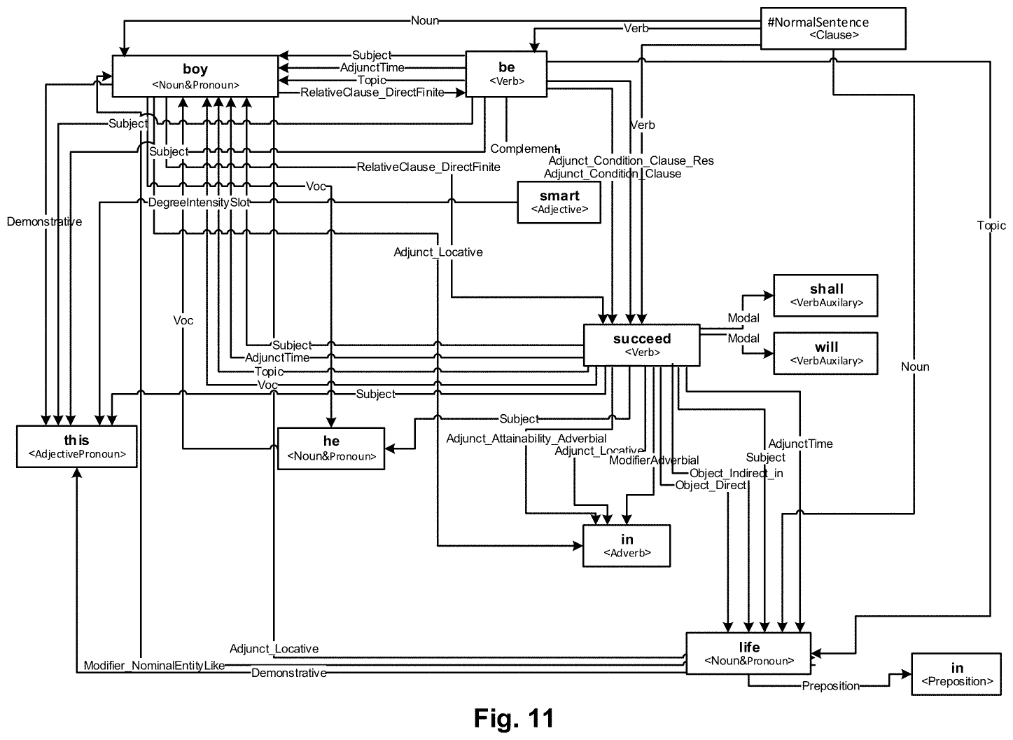

In certain implementations, the root of graph of generalized constituents 1033 represents a predicate. In the course of the above described process, the tree may become a graph, as certain constituents of a lower level may be included into one or more constituents of an upper level. A plurality of constituents that represent certain elements of the lexico-morphological structure may then be generalized to produce generalized constituents. The constituents may be generalized based on their lexical meanings or grammatical values 414, e.g., based on part of speech designations and their relationships. FIG. 11 schematically illustrates an example graph of generalized constituents.

Referring again to FIG. 3, at block 316, the computing system may perform precise syntactic analysis of sentence 312, to produce one or more syntactic trees 1043 of FIG. 10 based on graph of generalized constituents 1033. For each of one or more syntactic trees, the computing system may determine a general rating based on certain calculations and a priori estimates. The tree having the optimal rating may be selected for producing the best syntactic structure 1046 of original sentence 312.

In the course of producing the syntactic structure based on the selected syntactic tree, the computing system may establish one or more non-tree links (e.g., by producing redundant path between at least two nodes of the graph). If that process fails, the computing system may select a syntactic tree having a suboptimal rating closest to the optimal rating, and may attempt to establish one or more non-tree relationships within that tree. Finally, the precise syntactic analysis produces a syntactic structure which represents the best syntactic structure corresponding to original sentence 312. In fact, selecting the best syntactic structure also produces the best lexical values 340 of original sentence 312.

At block 317, the computing system may process the syntactic trees to produce a semantic structure 318 corresponding to sentence 312. Semantic structure 318 may reflect, in language-independent terms, the semantics conveyed by original sentence. Semantic structure 318 may be represented by an acyclic graph (e.g., a tree complemented by at least one non-tree link, such as an edge producing a redundant path among at least two nodes of the graph). The original natural language words are represented by the nodes corresponding to language-independent semantic classes of semantic hierarchy 510. The edges of the graph represent deep (semantic) relationships between the nodes. Semantic structure 318 may be produced based on analysis rules 460, and may involve associating, one or more features (reflecting lexical, syntactic, and/or semantic properties of the words of original sentence 312) with each semantic class.

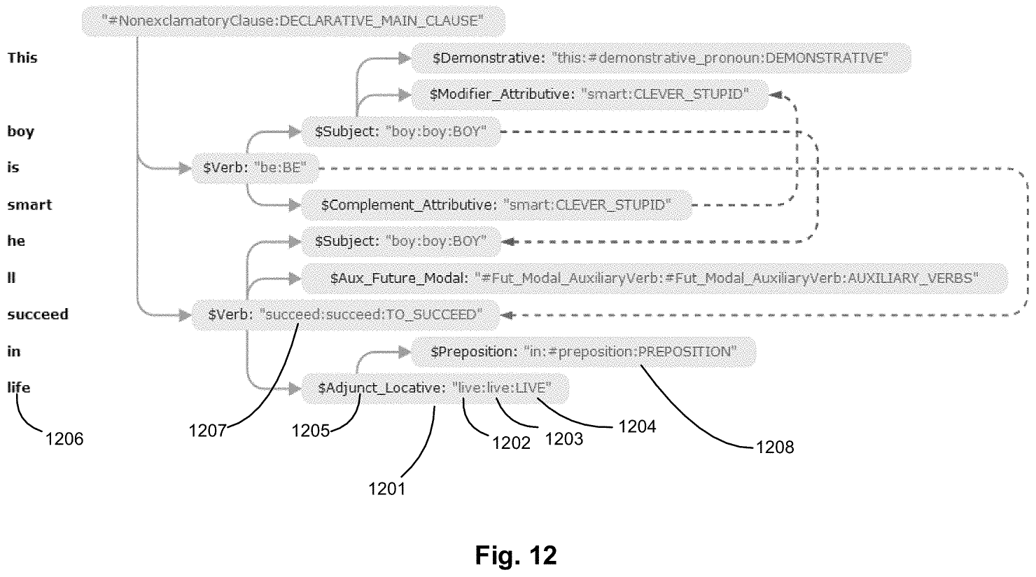

FIG. 12 illustrates an example syntactic structure of a sentence derived from the graph of generalized constituents illustrated by FIG. 11. Node 1201 corresponds to the lexical element “life” 1206 in original sentence 312. By applying the method of syntactico-semantic analysis described herein, the computing system may establish that lexical element “life” 1206 represents one of the lexemes of a lexical meaning “live” associated with a semantic class “LIVE” 1204, and fills in a surface slot $Adjunctr_Locative (1205) of the parent constituent, which is represented by a controlling node $Verb:succeed:succeed:TO SUCCEED (1207).

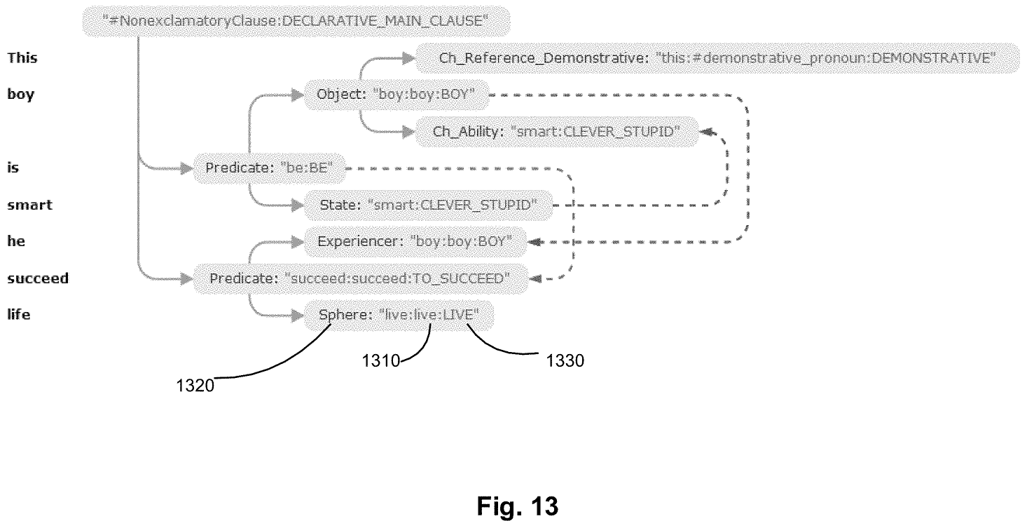

FIG. 13 illustrates a semantic structure corresponding to the syntactic structure of FIG. 12. With respect to the above referenced lexical element “life” 1206 of FIG. 12, the semantic structure comprises lexical class 1310 and semantic classes 1330 similar to those of FIG. 12, but instead of surface slot 1205, the semantic structure comprises a deep slot “Sphere” 1320.

In accordance with one or more aspects of the present disclosure, the computing system implementing the methods described herein may index one or more parameters yielded by the syntactico-semantic analysis. Thus, the methods described herein allow considering not only the plurality of words comprised by the original text corpus, but also pluralities of lexical meanings of those words, by storing and indexing all syntactic and semantic information produced in the course of syntactico-semantic analysis of each sentence of the original text corpus. Such information may further comprise the data produced in the course of intermediate stages of the analysis, the results of lexical selection, including the results produced in the course of resolving the ambiguities caused by homonymy and/or coinciding grammatical forms corresponding to different lexico-morphological meanings of certain words of the original language.

One or more indexes may be produced for each semantic structure. An index may be represented by a memory data structure, such as a table, comprising a plurality of entries. Each entry may represent a mapping of a certain semantic structure element (e.g., one or more words, a syntactic relationship, a morphological, lexical, syntactic or semantic property, or a syntactic or semantic structure) to one or more identifiers (or addresses) of occurrences of the semantic structure element within the original text.

In certain implementations, an index may comprise one or more values of morphological, syntactic, lexical, and/or semantic parameters. These values may be produced in the course of the two-stage semantic analysis, as described in more detail herein. The index may be employed in various natural language processing tasks, including the task of performing semantic search.

The computing system implementing the method may extract a wide spectrum of lexical, grammatical, syntactic, pragmatic, and/or semantic characteristics in the course of performing the syntactico-semantic analysis and producing semantic structures. In an illustrative example, the system may extract and store certain lexical information, associations of certain lexical units with semantic classes, information regarding grammatical forms and linear order, information regarding syntactic relationships and surface slots, information regarding the usage of certain forms, aspects, tonality (e.g., positive and negative), deep slots, non-tree links, semantemes, etc.

The computing system implementing the methods described herein may produce, by performing one or more text analysis methods described herein, and index any one or more parameters of the language descriptions, including lexical meanings, semantic classes, grammemes, semantemes, etc. Semantic class indexing may be employed in various natural language processing tasks, including semantic search, classification, clustering, text filtering, etc. Indexing lexical meanings (rather than indexing words) allows searching not only words and forms of words, but also lexical meanings, i.e., words having certain lexical meanings. The computing system implementing the methods described herein may also store and index the syntactic and semantic structures produced by one or more text analysis methods described herein, for employing those structures and/or indexes in semantic search, classification, clustering, and document filtering.

FIG. 14 illustrates a diagram of an example computing system 1000 which may execute a set of instructions for causing the computing system to perform any one or more of the methods discussed herein. The computing system may be connected to other computing system in a LAN, an intranet, an extranet, or the Internet. The computing system may operate in the capacity of a server or a client computing system in client-server network environment, or as a peer computing system in a peer-to-peer (or distributed) network environment. The computing system may be a provided by a personal computer (PC), a tablet PC, a set-top box (STB), a Personal Digital Assistant (PDA), a cellular telephone, or any computing system capable of executing a set of instructions (sequential or otherwise) that specify operations to be performed by that computing system. Further, while only a single computing system is illustrated, the term “computing system” shall also be taken to include any collection of computing systems that individually or jointly execute a set (or multiple sets) of instructions to perform any one or more of the methodologies discussed herein.

Exemplary computing system 1000 includes a processor 1402, a main memory 1404 (e.g., read-only memory (ROM) or dynamic random access memory (DRAM)), and a data storage device 1418, which communicate with each other via a bus 1430.

Processor 1402 may be represented by one or more general-purpose computing systems such as a microprocessor, central processing unit, or the like. More particularly, processor 1402 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 1402 may also be one or more special-purpose computing systems such as an application specific integrated circuit (ASIC), a field programmable gate array (FPGA), a digital signal processor (DSP), network processor, or the like. Processor 1402 is configured to execute instructions 1426 for performing the operations and functions discussed herein.

Computing system 1000 may further include a network interface device 1422, a video display unit 1410, a character input device 812 (e.g., a keyboard), and a touch screen input device 1414.

Data storage device 1418 may include a computer-readable storage medium 1424 on which is stored one or more sets of instructions 1426 embodying any one or more of the methodologies or functions described herein. Instructions 1426 may also reside, completely or at least partially, within main memory 1404 and/or within processor 1402 during execution thereof by computing system 1000, main memory 1404 and processor 1402 also constituting computer-readable storage media. Instructions 1426 may further be transmitted or received over network 1416 via network interface device 1422.

In certain implementations, instructions 1426 may include instructions of method 100 for document classification by confidentiality levels, in accordance with one or more aspects of the present disclosure. While computer-readable storage medium 1424 is shown in the example of FIG. 8 to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining,” “computing,” “calculating,” “obtaining,” “identifying,” “modifying” or the like, refer to the actions and processes of a computing system, or similar electronic computing system, that manipulates and transforms data represented as physical (e.g., electronic) quantities within the computing system's registers and memories into other data similarly represented as physical quantities within the computing system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Various other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method, comprising:
receiving, by a computing system, an electronic document comprising a natural language text;
obtaining document metadata associated with the electronic document;
extracting, from the natural language text, a plurality of information objects represented by the natural language text;
computing a confidentiality level associated with the electronic document, by applying, to the extracted information objects and the document metadata, a set of classification rules; and
associating the electronic document with a metadata item reflecting the computed confidentiality level.

2. The method of claim 1, further comprising:
applying, to the electronic document, a document retention policy corresponding to the computed confidentiality level.

3. The method of claim 1, further comprising:
redacting, from the electronic document, a textual annotation of an information object representing confidential information.

4. The method of claim 1, further comprising:
replacing, in the electronic document, a textual annotation of an information object representing confidential information with a fictitious data item.

5. The method of claim 1, wherein extracting plurality of information objects represented by the natural language text further comprises:
performing a lexico-morphological analysis of the natural language text.

6. The method of claim 1, wherein extracting plurality of information objects represented by the natural language text further comprises:
performing a syntactico-semantic analysis of at least a part of a natural language text comprised by the electronic document to produce a plurality of syntactico-semantic structures representing the part of the natural language text; and
applying, to a syntactico-semantic structure of the plurality of syntactico-semantic structures, a set of production rules that yields a category of an information object represented by the syntactico-semantic structure.

7. The method of claim 1, wherein extracting plurality of information objects represented by the natural language text further comprises:
performing a syntactico-semantic analysis of at least a part of a natural language text comprised by the electronic document to produce a plurality of syntactico-semantic structures representing the part of the natural language text;
applying, to a syntactico-semantic structure of the plurality of syntactico-semantic structures, a classifier function that yields a category of an information object represented by the syntactico-semantic structure.

8. The method of claim 1, wherein a classification rule of the set of classification rules specifies a document type and a corresponding confidentiality level.

9. The method of claim 1, wherein a classification rule of the set of classification rules specifies an information object category and a corresponding confidentiality level.

10. The method of claim 1, wherein computing the confidentiality level associated with the electronic document further comprises:
identifying a highest confidentiality level among confidentiality levels associated with a plurality of information objects represented by the natural language text.

11. A computer-readable non-transitory storage medium comprising executable instructions that, when executed by a computing system, cause the computing system to:
receive an electronic document comprising a natural language text;
obtain document metadata associated with the electronic document;
extract, from the natural language text, a plurality of information objects represented by the natural language text;
compute a confidentiality level associated with the electronic document, by applying, to the extracted information objects and the document metadata, a set of classification rules; and
associate the electronic document with a metadata item reflecting the computed confidentiality level.

12. The computer-readable non-transitory storage medium of claim 11, further comprising executable instructions that, when executed by a computing system, cause the computing system to:
apply, to the electronic document, a document retention policy corresponding to the computed confidentiality level.

13. The computer-readable non-transitory storage medium of claim 11, further comprising executable instructions that, when executed by a computing system, cause the computing system to:
redact, from the electronic document, a textual annotation of an information object representing confidential information.

14. The computer-readable non-transitory storage medium of claim 11, further comprising executable instructions that, when executed by a computing system, cause the computing system to:
replace, in the electronic document, a textual annotation of an information object representing confidential information with a fictitious data item.

15. The computer-readable non-transitory storage medium of claim 11, wherein extracting plurality of information objects represented by the natural language text further comprises:
performing a syntactico-semantic analysis of at least a part of a natural language text comprised by the electronic document to produce a plurality of syntactico-semantic structures representing the part of the natural language text; and
applying, to a syntactico-semantic structure of the plurality of syntactico-semantic structures, a set of production rules that yields a category of an information object represented by the syntactico-semantic structure.

16. The computer-readable non-transitory storage medium of claim 11, wherein extracting plurality of information objects represented by the natural language text further comprises:
performing a syntactico-semantic analysis of at least a part of a natural language text comprised by the electronic document to produce a plurality of syntactico-semantic structures representing the part of the natural language text;
applying, to a syntactico-semantic structure of the plurality of syntactico-semantic structures, a classifier function that yields a category of an information object represented by the syntactico-semantic structure.

17. The computer-readable non-transitory storage medium of claim 11, wherein a classification rule of the set of classification rules specifies a document type and a corresponding confidentiality level.

18. The computer-readable non-transitory storage medium of claim 11, wherein a classification rule of the set of classification rules specifies an information object category and a corresponding confidentiality level.

19. The computer-readable non-transitory storage medium of claim 11, wherein computing the confidentiality level associated with the electronic document further comprises executable instructions that, when executed by a computing system, cause the computing system to:
identify a highest confidentiality level among confidentiality levels associated with a plurality of information objects represented by the natural language text.

20. A computing system, comprising:
a memory; and
one or more processors, communicatively coupled to the memory, wherein the processors are configured to:
receive an electronic document comprising a natural language text;
obtain document metadata associated with the electronic document;
extract, from the natural language text, a plurality of information objects represented by the natural language text;
compute a confidentiality level associated with the electronic document, by applying, to the extracted information objects and the document metadata, a set of classification rules; and
associate the electronic document with a metadata item reflecting the computed confidentiality level.
